(19) United States
(12) Patent Application Publication
(10) Pub. No.: US 2004/0229535 A1
(43) Pub. Date: Nov. 18, 2004

(54) Anti-slide mat having high water absorptivity and for environmental protection purpose

(76) Inventor: Su-Tuan Hsu Tang, Tao Yuan City (TW)

Correspondence Address: TROXELL LAW OFFICE PLLC, SUITE 1404, 5205 LEESBURG PIKE, FALLS CHURCH, VA, 22041, US

(21) Appl. No.: 10/438,837

(22) Filed: May 16, 2003

(51) Int. Cl. B32B 27/04

(52) U.S. Cl. 442/59

(57) ABSTRACT

The present invention provides an anti-slide mat having high absorptivity and for environmental protection purpose. The present invention includes a cloth layer and an underlying anti-slide layer. In particular, the anti-slide paste forming the anti-slide layer is coated or sprayed on the bottom surface of the cloth layer. The anti-slide paste is further pressed to make it properly permeate into the cloth layer. The anti-slide paste is chosen form emulsified acrylic with lower permeability and the cloth layer is chosen from the cloth rich in fiber and with high water absorptivity, thereby the anti-slide paste slight permeates into the surface opposite to said base layer.

### BACKGROUND OF THE INVENTION

1. Field of the Invention

The present invention relates to an anti-slide mat having high water absorptivity and for environmental protection purpose, and more particularly to such an anti-slide mat that is easy to be produced.

2. Description of the Prior Art

Generally, the conventional anti-slide mat is used to fix object and not applicable to function as a sporting mat or floor mat placed in bathroom or outdoor. This is because the conventional anti-slide mat cannot absorb liquid, i.e. sweat. As a result, the sweat running down to the mat may make the user fall down. Alternatively, the accumulated sweat may make the user feel uncomfortable and cause the user catch a cold. Furthermore, if the user exercises on the conventional anti-slide mat and the skin of the user repeatedly contacts the sweat, the user is easy to have condyloma. Similarly, the conventional anti-slide mat cannot absorb water and is not suitable for the bathroom or outdoor use. The user may fall down when stepping on the conventional anti-slide mat placed in bathroom or outdoor.

For solving the foregoing problem, a conventional anti-slide mat is provided with a cloth layer on the surface of mat to provide water-absorbing function. However, in such the conventional anti-slide mat, since the surface cloth layer and the underlying anti-slide layer are combined with adhesive, the surface cloth layer and the bottom anti-slide layer are easy to be separated. Additionally, in the conventional anti-slide mat, if the anti-slide material is formed on bottom surface of the woolly layer directionally, the permeating and then congealed anti-slide material on the woolly layer may reduce the water absorptivity.

Further, the conventional anti-slide mat is made of PVC harmful to the human body when burned and failing to comply with the purpose of environmental protection.

### SUMMARY OF THE INVENTION

Therefore, the main object of the present invention is to provide an anti-slide mat having high absorptivity and for environmental protection purpose. Also, the present invention is suitable to the application of sporting mat, bathroom mat or floor mat. Besides, the present invention complies with the purpose of environmental protection since PVC is not contained.

The second object of the present invention is to provide an anti-slide mat with a rough surface formed on the bottom surface of the anti-slide layer, and thus increase the friction.

The third object of the present invention is to provide an anti-slide mat complying with the purpose of environmental protection. In the present invention, the anti-slide paste permeates into the surface, opposite to the base layer, of the cloth layer lightly, the increased bond between the cloth layer and the anti-slide layer is available. Therefore the life of the anti-slide mat is prolonged.

Further, the fourth object of the present invention is to provide an anti-slide mat, wherein the anti-slide paste is chosen from the emulsified acrylic with lower permeability and the cloth layer is chosen from the cloth rich in fiber and with high water absorptivity. As a result, the anti-slide paste slight permeates into the surface opposite to the base layer. That is, the anti-slide paste does not permeate into the woolly layer and thus keep the water absorptivity of the woolly layer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicting the method coating the anti-slide paste on the bottom surface of the cloth layer;

FIG. 2 depicting a partially enlarged perspective view of FIG. 1

FIG. 3 depicting a cross-sectional view of FIG. 2; and

FIG. 4 depicting a reversed perspective view of FIG. 2.

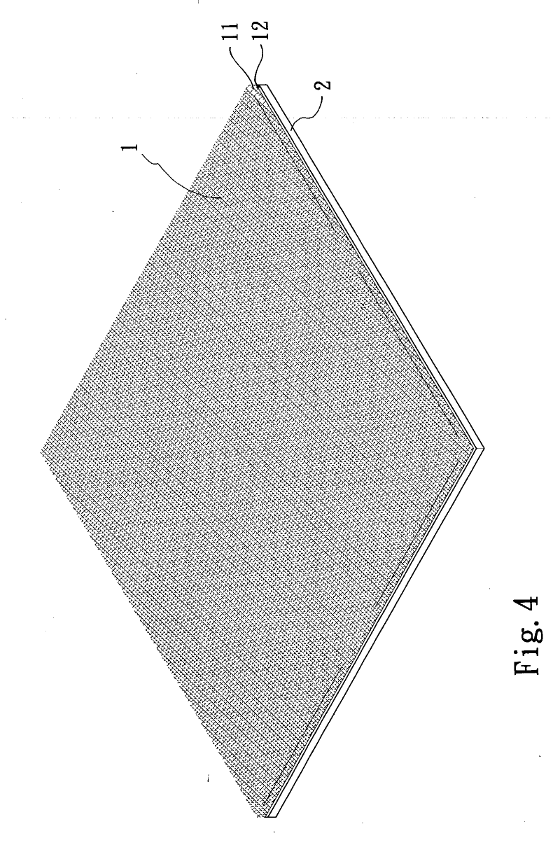

### DESCRIPTION OF THE PREFERRED EMBODIMENT

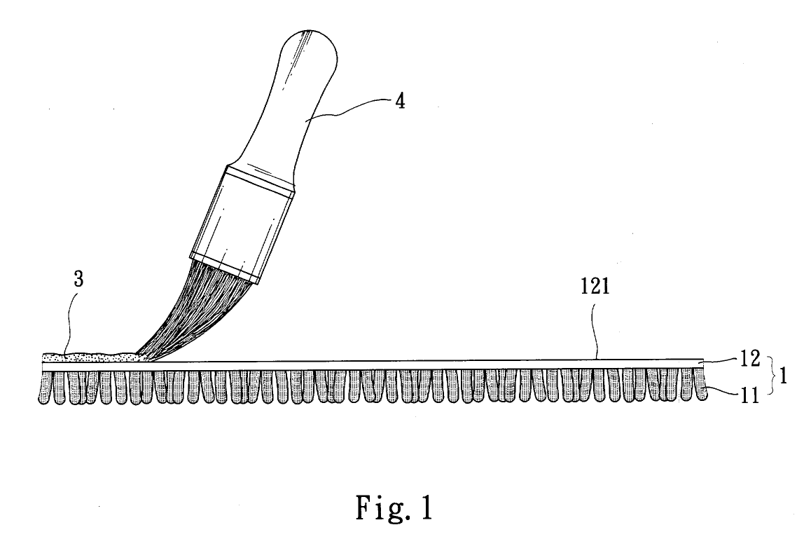

The present invention provides an anti-slide mat having high absorptivity and for environmental protection purpose. Referring to FIGS. 1-3, the present invention includes a cloth layer 1 and an underlying anti-slide layer 2. Among these, the cloth layer 1 may be made of any cloth, however, the cloth rich in fiber with high water absorptivity is preferred. The anti-slide layer 2 is anti-slide paste 3 before cooled down. The cloth layer 1 further includes a woolly layer 11 formed thereon.

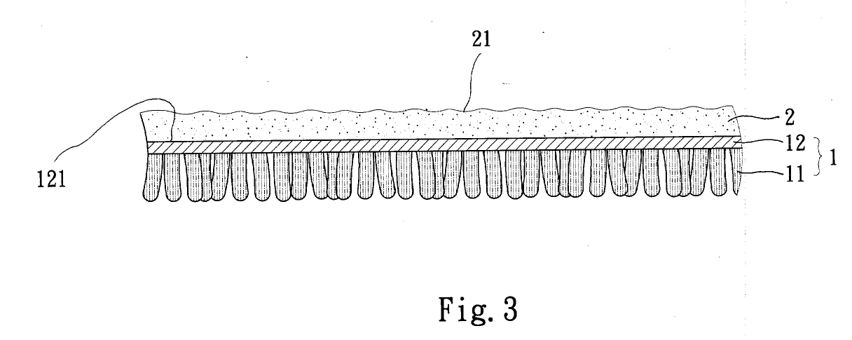

Referring to FIG. 3, the cloth layer 1 includes the woolly layer 11 and the base layer 12 thinner than the woolly layer 11. Therefore, the anti-slide paste with higher permeability is not suitable. This is because the anti-slide paste with relatively higher permeability may permeate into the woolly layer 11 through the surface 121, opposite to the base layer, and thus cause congealed anti-slide paste at the base of the woolly layer 11. As a result, the water absorptivity is reduced.

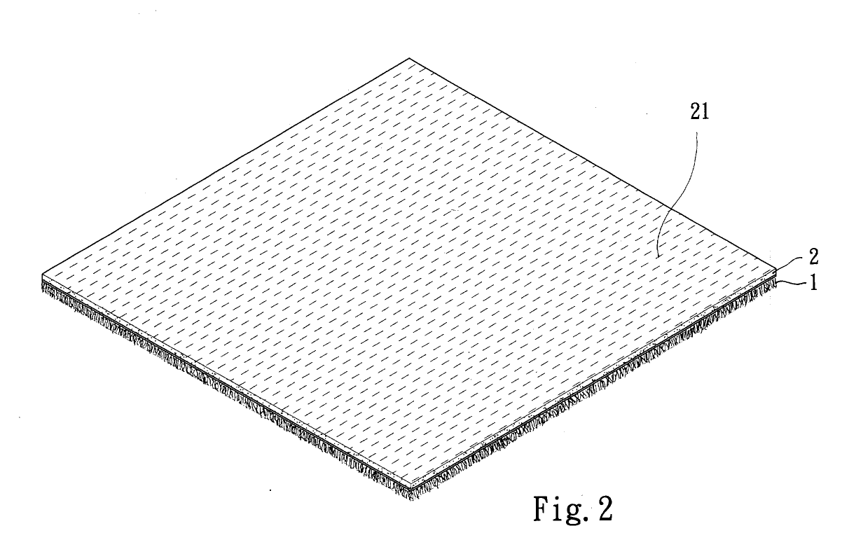

During manufacturing, the anti-slide paste 3 with lower permeability may be formed, in any manner, on the bottom surface, the surface 121 opposite to the base layer, of the cloth layer 1. For example, the anti-slide paste 3 maybe coated by the brush 4 in the painting manner shown in FIG. 1. Alternatively, the anti-slide paste 3 maybe formed by spraying. Until the anti-slide paste 3 has proper thickness, the anti-slide paste 3 is pressed to make it permeate into the cloth layer 1. For example, the anti-slide paste 3 is pressed by the brush to make it permeate into the cloth layer 1. After cooled down, the present anti-slide mat is completed. Note that, as shown in FIG. 2 and FIG. 3, the rough surface 21 is formed on the surface of the anti-slide layer 2 due to the bubble of heated emulsified acrylic. Thus, the friction is increased. Besides, since the anti-slide paste is chosen from the emulsified acrylic with lower permeability, the cloth layer 1 is chosen from the cloth rich in fiber and with high water absorptivity. As a result, the anti-slide paste 3 slight permeates into the surface 121 opposite to the base layer. That is, the anti-slide paste 3 does not permeate into the woolly layer 11 and thus make the woolly layer 11 keep the water absorptivity.

Since the anti-slide paste 3 slight permeates into the surface 121, opposite to the base layer 12, and does not permeate into the woolly layer 11, the water absorptivity is kept. Therefore, the anti-slide mat having such the foregoing structure cannot reduce slippage but also provides excellent water or sweat absorptivity due to the anti-slide layer 2 and the cloth layer 1.

The anti-slide layer 2 is preferably made of emulsified acrylic and thus includes the advantages as follows. First, the emulsified acrylic has relatively lower permeability. The emulsified acrylic does not permeate into the woolly layer 11 of the cloth layer 1. Accordingly, the present anti-slide mat provides high water absorptivity. Second, the burned emulsified acrylic does not release any poison gas harmful to the human body and thus prevents environmental pollution. Third, the rough surface 21, opposite to the surface attaching to the cloth layer 1, is formed and thus increases the friction.

Further, since the anti-slide paste 3 permeates into the surface 121, opposite to the base layer, of the cloth layer 1 lightly, the increased bond between the cloth layer 1 and the anti-slide layer 2 is available. Therefore the life of the anti-slide mat is prolonged.

The disadvantages of the present invention are described as below. First, High water absorptivity is available since emulsified acrylic has relatively lower permeability and thus the absorptivity of the wooly layer is kept. Hence, the present anti-slide mat is suitable to function as a sporting mat or Yoga mat, or function as the floor mat placed at the wet bathroom or outdoors. Second, the present anti-slide mat reduce slippage and complies with the purpose of environmental protection since the material of the anti-slide layer 2 is chosen from emulsified acrylic instead of PVC. Besides, the burned emulsified acrylic does not release any poison gas harmful to the human body. Third, emulsified acrylic can increase friction and form the rough surface 121 alter cooled down down. Fourth, the manufacturing process is simplified since emulsified acrylic with lower permeability is formed on the cloth layer I with brush. Such the process can be done without any machine.

As described above, the present invention provides an anti-slide mat having high water absorptivity and for environmental protection. The present invention improves the water absorptivity of conventional anti-slide mat. Therefore, the present invention meets the requirement of novelty and non-obviousness. As is understood by the person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An anti-slide mat having high water absorptivity and for environmental protection, comprising a cloth layer and an underlying anti-slide layer, the anti-slide mat comprising:
coating or spraying an anti-slide paste on the bottom surface of said cloth layer;
pressing said anti-slide paste to make said anti-slide paste slight permeate into said cloth layer;
cooling said anti-slide paste, thereby forming said anti-slide layer on said bottom surface of said cloth layer.

2. The anti-slide mat according to claim 1, wherein said anti-slide paste is chosen form emulsified acrylic.

3. The anti-slide mat according to claim 1, wherein said anti-slide layer further comprises a rough surface to increase friction.

4. The anti-slide mat according to claim 1, wherein said cloth layer further comprises a woolly layer, wherein said anti-slide paste is chosen from emulsified acrylic with lower permeability and said cloth layer is chosen from the cloth rich in fiber and with high water absorptivity, thereby the anti-slide paste slight permeates into the surface opposite to said base layer.

5. The anti-slide mat according to claim 1, wherein said cloth layer is chosen from the cloth rich in fiber and with high water absorptivity.

6. The anti-slide mat according to claim 1, wherein said anti-slide paste is coated by brush.
